(19) United States
(12) Patent Application Publication
(10) Pub. No.: US 2023/0077998 A1
(43) Pub. Date: Mar. 16, 2023

(54) Systems and Methods for Smart Instance Selection

(71) Applicant: Virtualitics, Inc., Pasadena, CA (US)

(72) Inventors: Anthony Pineci, Pasadena, CA (US); Ebube Chuba, Pasadena, CA (US); Aakash Indurkhya, Pasadena, CA (US); Sarthak Sahu, Pasadena, CA (US); Ciro Donalek, Pasadena, CA (US); Michael Amori, Pasadena, CA (US)

(73) Assignee: Virtualitics, Inc., Pasadena, CA (US)

(21) Appl. No.: 17/933,021

(22) Filed: Sep. 16, 2022

Related U.S. Application Data
(60) Provisional application No. 63/245,167, filed on Sep. 16, 2021.

(51) Int. Cl. G06N 5/04; G06N 5/02

(52) U.S. Cl. CPC G06N 5/045; G06N 5/022

(57) ABSTRACT

Systems and methods for smart instance selection in accordance with embodiments of the invention are illustrated. One embodiment includes a system for selecting explanatory instances in datasets, including a processor, and a memory, the memory containing an instance selection application that configures the processor to: obtain a dataset comprising a plurality of records, obtain a machine learning model configured to classify records, initialize an explainer model, select at least one key instance from the dataset estimated to have explanatory power when provided to the explainer model, provide the explainer model with the selected at least one key instance; and provide an explanation produced by the explainer model.

### CROSS-REFERENCE TO RELATED APPLICATIONS

The current application claims the benefit of and priority under 35 U.S.C. § 119(e) to U.S. Provisional Patent Application No. 63/245,167 entitled “Systems and Methods for Smart Instance Selection” filed Sep. 16, 2021. The disclosure of U.S. Provisional Patent Application No. 63/245,167 is hereby incorporated by reference in its entirety for all purposes.

### FIELD OF THE INVENTION

This invention generally relates to machine learning and data comprehensibility, and specifically to the identification of key instances in a dataset that provide explainability.

### BACKGROUND

Big data is a field that focuses on ways to analyze, systematically extract information from, or otherwise deal with data sets that are too large or complex to be dealt with by traditional data processing methods. Datasets typically contain many instances (or “records”) which constitute individual datum. Records may also be referred to as “points” when visualized as a node in a visualization. Each instance may have values associated with a number of dimensions. For example, in a tabular dataset, instances are rows, whereas columns are dimensions. The values in each cell in a row are the values for the particular dimension of the corresponding column.

### SUMMARY OF THE INVENTION

Systems and methods for smart instance selection in accordance with embodiments of the invention are illustrated. One embodiment includes a system for selecting explanatory instances in datasets, including a processor, and a memory, the memory containing an instance selection application that configures the processor to: obtain a dataset comprising a plurality of records, obtain a machine learning model configured to classify records, initialize an explainer model, select at least one key instance from the dataset estimated to have explanatory power when provided to the explainer model, provide the explainer model with the selected at least one key instance; and provide an explanation produced by the explainer model.

In another embodiment, wherein to select at least one key instance, the instance selection application further configures the processor to: run a regression model on the dataset, calculate distances between each record in the dataset, and select pairs of records in the dataset that are less than 0.5 in distance and greater than 90% different in output when provided to the regression model.

In a further embodiment, wherein distances are calculated using ball tree nearest neighbors.

In still another embodiment, wherein to select at least one key instance, the instance selection application further configures the processor to: classify each point in the data set using the machine learning model, calculate distances between each record in the dataset, and select pairs of records in the data set that are less than 0.5 in distance and different in classification.

In a still further embodiment, wherein to select at least one key instance, the instance selection application further configures the processor to: repeatedly classify, using the machine learning model, each record in the dataset after applying Gaussian noise to each record, calculate a wobbliness value for each record in the dataset, generate a sorted list of records ordered from highest wobbliness value to lowest wobbliness value, and provide the number of records from the sorted list having the highest wobbliness values as selected instances.

In yet another embodiment, the instance selection application further configures the processor to: cluster the dataset, select representative records from centermost records in each cluster, and select the at least one key instance from the representative records.

In a yet further embodiment, to cluster the dataset, the instance selection application further configures the processor to apply HDBSCAN.

In another additional embodiment, the instance selection application further configures the processor to visualize the explanation using the display.

In a further additional embodiment, the display is a virtual reality headset.

In another embodiment again, the virtual reality headset renders a multi-user virtual office space.

In a further embodiment again, a method for selecting explanatory instances in datasets, including: obtaining a dataset including a plurality of records, obtaining a machine learning model configured to classify records, initializing an explainer model, selecting at least one key instance from the dataset estimated to have explanatory power when provided to the explainer model, providing the explainer model with the selected at least one key instance, and providing an explanation produced by the explainer model.

In still yet another embodiment, wherein selecting at least one key instance includes running a regression model on the dataset, calculating distances between each record in the dataset, and selecting pairs of records in the dataset that are less than 0.5 in distance and greater than 90% different in output when provided to the regression model.

In a still yet further embodiment, distances are calculated using ball tree nearest neighbors.

In still another additional embodiment, wherein selecting at least one key instance includes classifying each point in the data set using the machine learning model, calculating distances between each record in the dataset, and selecting pairs of records in the data set that are less than 0.5 in distance and different in classification.

In a still further additional embodiment, wherein selecting at least one key instance includes: repeatedly classifying, using the machine learning model, each record in the dataset after applying Gaussian noise to each record, calculating a wobbliness value for each record in the dataset, generating a sorted list of records ordered from highest wobbliness value to lowest wobbliness value, and providing the number of records from the sorted list having the highest wobbliness values as selected instances.

In still another embodiment again, the method further includes clustering the dataset, selecting representative records from centermost records in each cluster, and selecting the at least one key instance from the representative records.

In a still further embodiment again, clustering the dataset comprises applying HDBSCAN.

In yet another additional embodiment, the method further includes visualizing the explanation using a display.

In a yet further additional embodiment, the display is a virtual reality headset. In yet another embodiment again, the virtual reality headset renders a multi-user virtual office space.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIG. 1 is a smart instance selection system in accordance with an embodiment of the invention.

FIG. 2 conceptually illustrates a smart instance in accordance with an embodiment of the invention.

FIG. 3 is a flow chart illustrating a process for selecting an instance for use in explaining data in accordance with an embodiment of the invention.

FIG. 4 is a flow chart for selecting an instance from a data set using regression in accordance with an embodiment of the invention.

FIG. 5 is a flow chart for selecting an instance from a data set using regression in accordance with another embodiment of the invention.

FIG. 6 is a flow chart for selecting an instance from a data set using regression in accordance with yet another embodiment of the invention.

FIG. 7 is a flow chart for selecting an instance from a data set using classification in accordance with an embodiment of the invention.

FIG. 8 is a flow chart for selecting an instance from a data set using classification in accordance with another embodiment of the invention.

FIG. 9 is a flow chart for selecting an instance from a data set using classification in accordance with yet another embodiment of the invention.

FIG. 10 is a flow chart for selecting an instance from a data set using classification in accordance with yet another again embodiment of the invention.

FIG. 11 is a flow chart for selecting an instance from a data set using dataset size reduction in accordance with an embodiment of the invention.

FIG. 12 is a flow chart for selecting an instance from a data set using dimensionality reduction in accordance with an embodiment of the invention.

FIG. 13 is a flow chart for selecting an instance from a data set using viability metrics in accordance with an embodiment of the invention.

### DETAILED DESCRIPTION

Big data is more and more becoming an integral part of many commercial and academic fields. The rise of machine learning techniques in particular have enabled functionality not previously capable by computing devices. A fundamental functionality of machine learning is the ability to classify and predict based on an input. However, many machine learning models are not “interpretable” in that there is no consistent way for a human to see how the model reached its prediction. For example, “black box” machine learning models provide an output when given an input, but provide no explanation as to how the output was obtained.

In order to provide insight into why a machine learning model makes a prediction, another type of machine learning model referred to as an “explainer” has been developed. Generally, explainers can be provided with a machine learning model and input data, and provide information about which aspects of the input resulted in the output prediction. There are many different implementations of explainers such as (but not limited to) Lime by Dr. Marco Tulio Correia Ribeiro, and SHAP (Shapley Additive exPlanations) by Dr. Scott Lundberg. However, a limitation of explainers is that they need to operate on one input at a time. With large datasets, running every instance could take an extreme amount of processing power and/or time. Even if running every instance as input to an explainer were feasible, it would produce an equally large amount of data which might be difficult to process yet again.

Systems and methods described herein provide automated processes for selecting specific instances from a dataset to run through an explainer to provide maximum insight for a user. In this way, significant amounts of processing power and/or time can be saved. In various embodiments, these processes can be provided as a module of a data processing system like those described in U.S. application Ser. No. 17/226,943 titled “Systems and Methods for Dataset Merging using Flow Structures”, the disclosure of which is hereby incorporated by reference. Smart instance selection systems are described in further detail below.

### Smart Instance Selection Systems

Smart instance selection systems are capable of processing datasets to automatically select one or more instances from the datasets which provide sufficient explanation as to why a machine learning model makes certain predictions for certain instances. In many embodiments, smart instance selection systems are part of a larger data visualization system such as (but not limited to) VIP—Virtualitics Immersive Platform, by Virtualitics Inc. of Pasadena, Calif. In various embodiments, smart instance selection systems can operate with any number of different types of machine learning models that operate on any number of different types of datasets. Smart instance selection systems can provide selected instances to one or more explainers to provide explanations of the machine learning models. Further, in various embodiments, partial dependence plots can be provided to help aid human understanding.

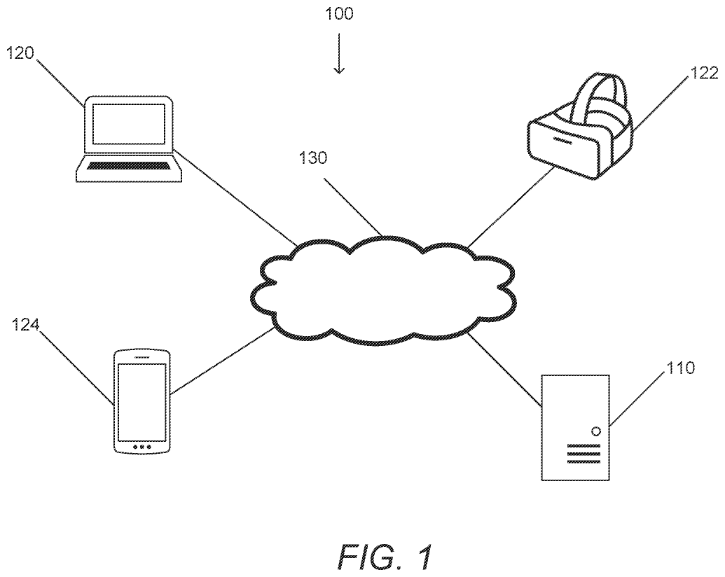

Turning now to FIG. 1, a smart instance selection system architecture in accordance with an embodiment of the invention is illustrated. Smart instance selection system 100 includes a smart instance selector 110. Smart instance selectors are computing platforms capable of performing instance selection processes. In various embodiments, smart instance selectors are personal computers. However, they can be implemented using any number of different types of computing platforms. In various embodiments, smart instance selectors can be implemented as a cloud service on a server system. System 100 further includes a number of interface devices such as computer 120, virtual reality (VR) system 122, and smartphone 124. While these particular interface devices are illustrated in FIG. 1, any number of different types of computing platforms which enable user interaction and/or display can be used as appropriate to the requirements of specific applications of embodiments of the invention. Interface devices are connected to the smart instance selector by a network 130. In many embodiments, the network is the Internet. However, any number of different network types, both wired and wireless, and/or combinations of different networks can be used. In some embodiments, smart instance selectors have integrated interface devices. In many embodiments, the interface device displays a virtual office space in which data can be visualized in three dimensions with one or more users.

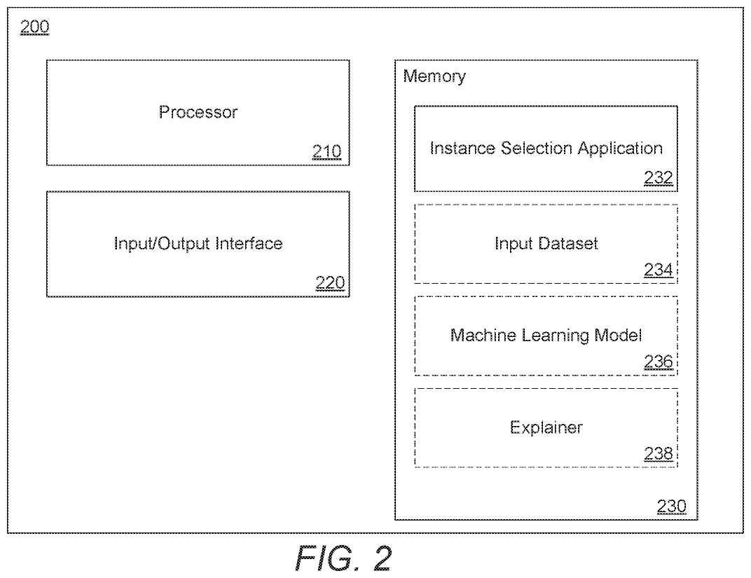

Turning now to FIG. 2, a block diagram for a smart instance selector in accordance with an embodiment of the invention is illustrated. Smart instance selector 200 includes a processor 210. Processor 210 can be implemented as any number of different logic processing circuitries including (but not limited to) central processing units (CPUs), graphics processing units (GPUs), field-programmable gate arrays (FPGAs), application-specific integrated circuits (ASICs), and/or as any other logic processing circuit and/or combination thereof as appropriate to the requirements of specific applications of embodiments of the invention.

Smart instance selector 200 further includes an input/output (I/O) interface 220. I/O interfaces can be used to communicate with other computing devices (e.g. interface devices) and/or other displays. Smart instance selector 200 further includes a memory 230. Memory can be implemented as volatile memory, non-volatile memory, and/or any combination thereof. The memory 230 contains an instance selection application 232. The instance selection application can direct the processor to carry out various instance selection processes. In various embodiments, the memory 230 contains (potentially at different points) input dataset 234, a machine learning model 236, and an explainer 238. Input datasets contain instances which the machine learning model is trained to classify. The explainer is a tool trained to explain the prediction process of the machine learning model given an instance and the machine learning model. As can be readily appreciated, the memory may contain multiple input datasets, machine learning models, and/or explainers as appropriate to the requirements of specific applications of embodiments of the invention.

While particular system architectures are discussed above, as can be readily appreciated, any number of computer architectures can be used to implement instance selection processes as appropriate to the requirements of specific applications of embodiments of the invention. Instance selection processes are discussed further below.

### Smart Instance Selection

Smart instance selection involves choosing instances in a dataset which provide significant expandability about the dataset and/or how it is being predicted by a machine learning model. For example, selection of an instance with high explainability value can provide insight into which data dimensions are most responsible for a particular prediction. The selected instances can then be provided to one or more explainers and the resulting explanations can be provided to a user.

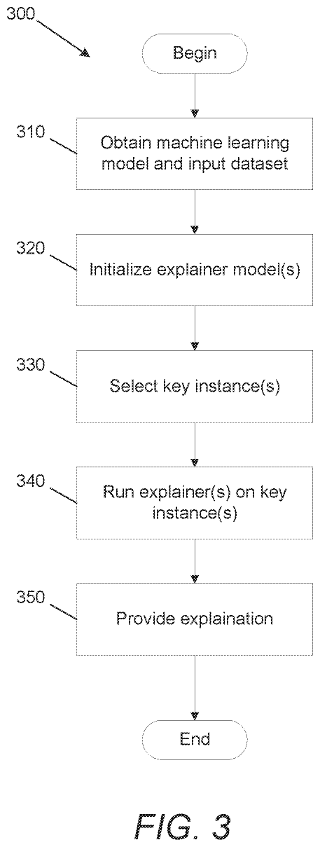

Turning now to FIG. 3, a process for selecting an instance and providing an explanation to a user in accordance with an embodiment of the invention is illustrated. Process 300 includes obtaining (310) a machine learning model and an input dataset. In many embodiments, the machine learning model has been trained to predict instances in the input dataset. One or more explainer models are initialized (320), i.e. trained to provide explanations when provided an instance from the input dataset and the machine learning model. One or more key instances are selected (330) from the input dataset which provide high explainability, and the explainer(s) is run (340) using the selected key instance(s). The explainer(s) output is provided (350) as an explanation of the machine learning model.

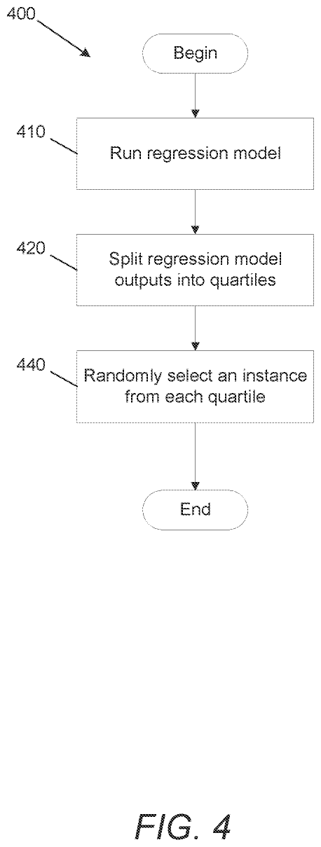

As can be readily appreciated, selection of the one or more key instances is a non-trivial problem, especially in the context of big data. In order to select a useful instance (or relatively small subset of instances) from a dataset, processes described herein can perform one or more selection processes which are described in further detail below. In various embodiments, multiple selection processes are utilized. In various embodiments, instances that are selected across multiple selection processes are provided, (i.e. the intersection of the sets of selected instances across multiple methods), although all selected instances can be provided as well (i.e. the union). In many embodiments, if an instance is selected at least a threshold number of times across multiple selection processes, that instance is again selected for final provisioning to an explainer. FIGS. 4-13 illustrate different selection processes in accordance with embodiments of the invention.

### A. Regression Selection

Turning now to FIG. 4, a selection process using regression in accordance with an embodiment of the invention is illustrated. Process 400 includes running (410) a regression model on the input data set. The regression model outputs are split (420) into quartiles. A random instance from each quartile is then selected (440) to form the set of selected key instances.

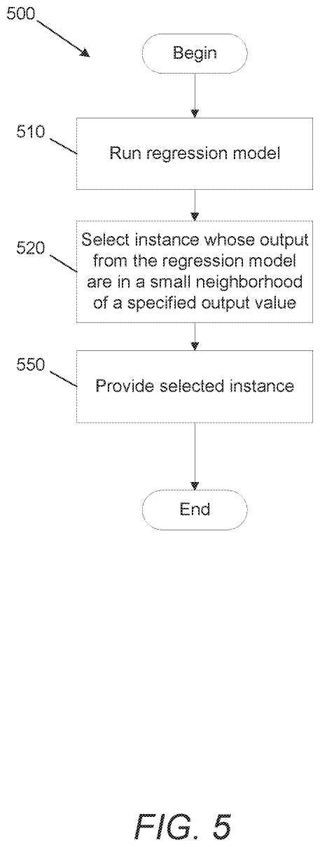

Turning now to FIG. 5, an alternative selection process using regression in accordance with an embodiment of the invention is illustrated. Process 500 includes running (510) a regression model on the input data set. Instances whose output from the regression model are in a small neighborhood of a specified output value are selected (520) and provided (530) as the selected key instances.

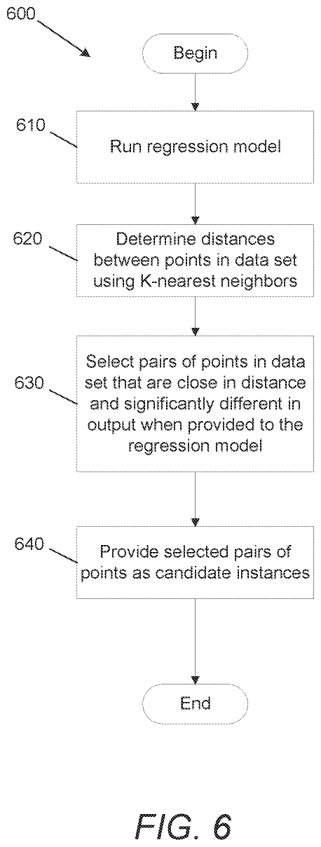

Turning now to FIG. 6, yet another selection process using regression in accordance with an embodiment of the invention is illustrated. Process 600 includes running (610) a regression model on the input data set. Distances between points in the data set are determined (620) using a K-nearest neighbors approach. In many embodiments, a ball tree nearest neighbors algorithm is applied, however any number of different nearest neighbors implementations can be utilized without departing from the scope or spirit of the invention.

Pairs of points in the data set that are close in distance and significantly different in output from the regression model are selected (630). In many embodiments, pairs of points that are sufficiently close are selected based on a specified distance threshold. In various embodiments, the specified threshold is between 0.4 and 0.6, e.g. close=distance less than 0.5. Significant difference in output can be formalized as pairs of points having a percentile of difference in reference to other pairs greater than at least a difference threshold, e.g. greater than at least 90%. Depending on the amount of data, these numbers can be tuned to produce fewer selected pairs. The points in the selected pairs are then provided (640) as candidate instances.

### B. Classification Selection

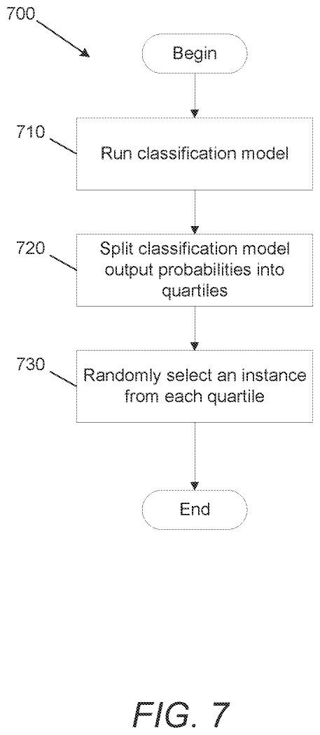

Turning now to FIG. 7, a selection process using classification in accordance with an embodiment of the invention is illustrated. Process 700 includes running (710) a classification model on the input dataset and the outputs of the classification model are split (720) into quartiles. A random instance from each quartile is selected (730) to form the set of selected key instances.

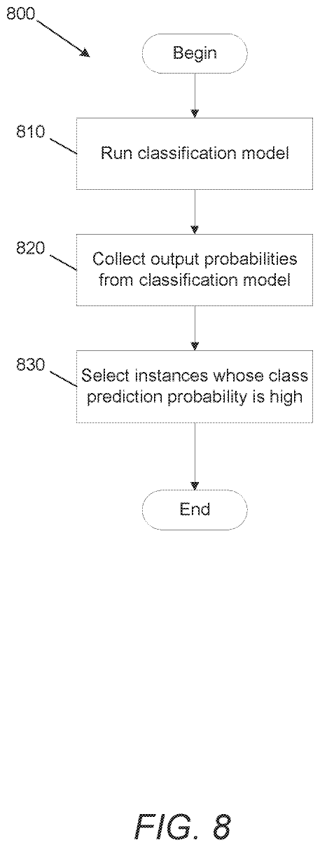

Turning now to FIG. 8, an alternative selection process using classification in accordance with an embodiment of the invention is illustrated. Process 800 includes running (810) A classification model is run input dataset. Output probabilities from the classification model are collected (820) and instances whose class prediction probability is high are selected to form the set of selected key instances.

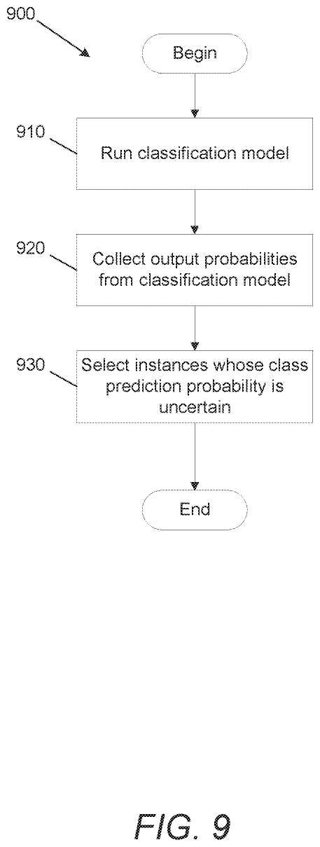

Turning now to FIG. 9, yet another alternative selection process using classification in accordance with an embodiment of the invention is illustrated. Process 900 includes running (910) a classification model on the input dataset. Output probabilities from the classification model are collected (920) and instances whose class prediction probability are uncertain are selected (930) to form the set of selected key instances.

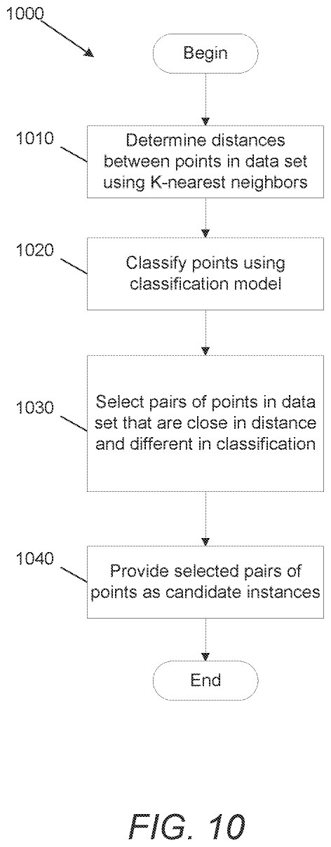

Turning now to FIG. 10, another selection process using classification in accordance with an embodiment of the invention is illustrated. Process 1000 includes determining (1010) distances between points in the data set using K-nearest neighbors. In many embodiments, a ball tree nearest neighbors algorithm is applied, however any number of different nearest neighbors implementations can be utilized without departing from the scope or spirit of the invention. Points in the data set are classified (1020) using a classification model. Pairs of points in the data set that are close in distance and different in classification are selected (1030). In numerous embodiments, points below a specified threshold are identified as close. In various embodiments, the specified threshold is between 0.4 and 0.6, e.g. close=distance less than 0.5. In many embodiments, the specified threshold is 0.5. The selected points are provided (1040) as candidate instances.

### C. Reduction Selection

Datasets may be too large to efficiently compute metrics for each point. In such instances, it can be helpful to reduce the amount of computational power required to generate candidate instances by reducing the number of points to be considered in the analysis. Reduction selection methods operate by reducing the number of points to be considered by other modalities described herein.

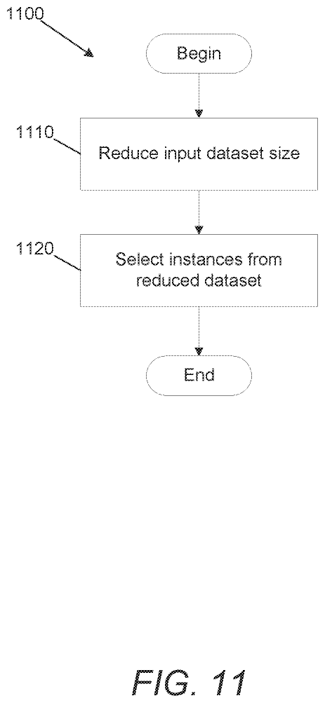

Turning now to FIG. 11, a selection process using dataset size reduction in accordance with an embodiment of the invention is illustrated. Process 1100 includes reducing (1110) the input dataset size. In many embodiments, any number of different dataset reduction methods can be used including (but not limited to) boundary preserving selection, dense instance neighborhood selection, and/or any other size reduction method can be used as appropriate to the requirements of specific applications of embodiments of the invention. In numerous embodiments, a clustering algorithm is applied to the data, and the centermost point from each cluster is selected. In many embodiments, the N centermost points from each cluster are selected. N can be a value selected to meet a specific desired number of points, e.g. desired total number of points=N*number of clusters. N can also be a standard flat number, e.g. 5, 10, 100, depending on the total size of the dataset.

In numerous embodiments, HDBSCAN is used to cluster the dataset (described in Campello et al. (2013). Density-Based Clustering Based on Hierarchical Density Estimates. Advances in Knowledge Discovery and Data Mining. PAKDD 2013. Lecture Notes in Computer Science, vol 7819. Springer, Berlin, Heidelberg.) However, as noted above, any number of different clustering algorithm can be applied, noting however that outlier detection is a desirable feature in many use cases. Instances are selected (1120) form the reduced dataset as the set of selected key instances using any of the selection modalities described herein.

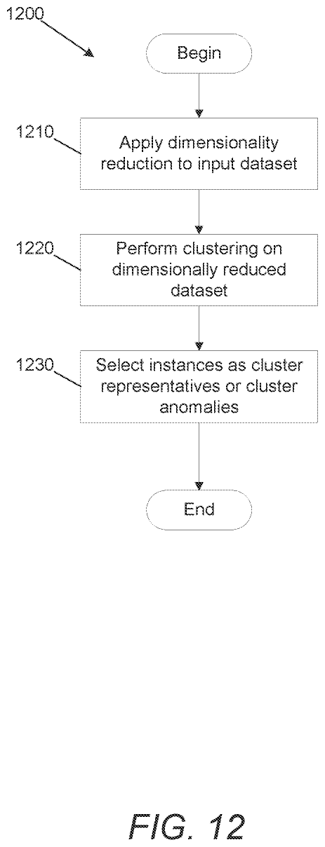

Turning now to FIG. 12, a selection process using dimensionality reduction in accordance with an embodiment of the invention is illustrated. Process 1200 includes applying a dimensionality reduction to the input dataset. Any number of different dimensionality reduction methods can be applied including (but not limited to) principal component analysis (PCA), t-distributed stochastic neighborhood embedding (t-SNE), and/or any other dimensionality reduction process as appropriate to the requirements of specific applications of embodiments of the invention. Clustering can then be performed (1220) on the dimensionally reduced dataset and instances that are cluster representatives and/or cluster anomalies are selected (1230) as instances for the set of key instances. In some embodiments, representatives and/or cluster anomalies are provided to other selection modalities for final key instance selection.

In various embodiments, anomaly detection can be used on the input dataset (and/or the dimensionally reduced dataset), and anomalous instances can be selected as key instances. In various embodiments, anomaly detection can be performed using local outlier factor, isolation forest, and/or any other anomaly detection process as appropriate to the requirements of specific applications of embodiments of the invention.

### D. Viability Metric Selection

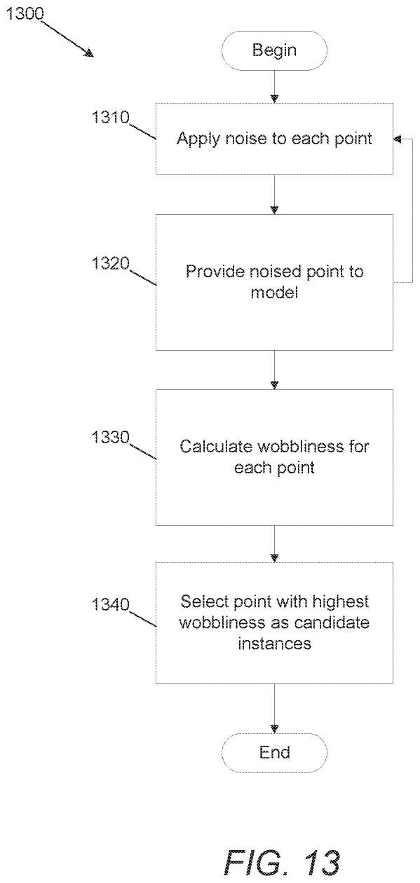

In many embodiments, wobbliness can be used as a viability metric for instances in the input dataset which reflect estimated explainability. Wobbliness is described in Grosse et al. Backdoor Smoothing: Demystifying Backdoor Attacks on Deep Neural Networks. arXiv:2006.06721. Jun. 11, 2022. Turning now to FIG. 13, a process for instance selection based on wobbliness in accordance with an embodiment of the invention is illustrated. Process 1300 includes applying (1310) noise to each point in the dataset. In many embodiments, the noise is Gaussian. Each noised point is then provided (1320) to a classification model. In many embodiments, points in the dataset have a different noise applied to them and are classified again to build up a vector of multiple different classifications. The number of iterations is selected as such to be sufficient to validly calculate wobbliness. In many embodiments, the number of iterations is between 10 and 300. Wobbliness is calculated (1330) for each point, and points with the highest wobbliness are selected (1340) as candidate instances. In numerous embodiments, an ordered list of candidate instances (which may be arbitrarily truncated depending on user preference, or a predefined threshold) is provided, ordered from most wobbly to least wobbly.

As can readily be appreciated, any number of different instance selection methods can be used as appropriate to the requirements of specific applications of embodiments of the invention. Further, methods described herein can be applied to parts of a dataset or a dimensionally reduced datasets. Indeed, multiple instance selection processes can be used without departing from the scope or spirit of the invention.

Although specific systems and methods are discussed herein, many different methods and system architectures can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A system for selecting explanatory instances in datasets, comprising:
a processor; and
a memory, the memory containing an instance selection application that configures the processor to:
obtain a dataset comprising a plurality of records;
obtain a machine learning model configured to classify records;
initialize an explainer model;
select at least one key instance from the dataset estimated to have explanatory power when provided to the explainer model;
provide the explainer model with the selected at least one key instance; and
provide an explanation produced by the explainer model.

2. The system of claim 1, wherein to select at least one key instance, the instance selection application further configures the processor to:
run a regression model on the dataset;
calculate distances between each record in the dataset; and
select pairs of records in the dataset that are less than 0.5 in distance and greater than 90% different in output when provided to the regression model.

3. The system of claim 2, wherein distances are calculated using ball tree nearest neighbors.

4. The system of claim 1, wherein to select at least one key instance, the instance selection application further configures the processor to:
classify each point in the data set using the machine learning model;
calculate distances between each record in the dataset; and
select pairs of records in the data set that are less than 0.5 in distance and different in classification.

5. The system of claim 1, wherein to select at least one key instance, the instance selection application further configures the processor to:
repeatedly classify, using the machine learning model, each record in the dataset after applying Gaussian noise to each record;
calculate a wobbliness value for each record in the dataset;
generate a sorted list of records ordered from highest wobbliness value to lowest wobbliness value; and
provide the number of records from the sorted list having the highest wobbliness values as selected instances.

6. The system of claim 1, wherein the instance selection application further configures the processor to:
cluster the dataset;
select representative records from centermost records in each cluster; and
select the at least one key instance from the representative records.

7. The system of claim 6, wherein to cluster the dataset, the instance selection application further configures the processor to apply HDBSCAN.

8. The system of claim 1, further comprising a display, where the instance selection application further configures the processor to visualize the explanation using the display.

9. The system of claim 8, wherein the display is a virtual reality headset.

10. The system of claim 9, wherein the virtual reality headset renders a multi-user virtual office space.

11. A method for selecting explanatory instances in datasets, comprising:
obtaining a dataset comprising a plurality of records;
obtaining a machine learning model configured to classify records;
initializing an explainer model;
selecting at least one key instance from the dataset estimated to have explanatory power when provided to the explainer model;
providing the explainer model with the selected at least one key instance; and
providing an explanation produced by the explainer model.

12. The method of claim 11, wherein selecting at least one key instance comprises:
running a regression model on the dataset;
calculating distances between each record in the dataset; and
selecting pairs of records in the dataset that are less than 0.5 in distance and greater than 90% different in output when provided to the regression model.

13. The method of claim 12, wherein distances are calculated using ball tree nearest neighbors.

14. The method of claim 11, wherein selecting at least one key instance comprises:
classifying each point in the data set using the machine learning model;
calculating distances between each record in the dataset; and
selecting pairs of records in the data set that are less than 0.5 in distance and different in classification.

15. The method of claim 11, wherein selecting at least one key instance comprises:
repeatedly classifying, using the machine learning model, each record in the dataset after applying Gaussian noise to each record;
calculating a wobbliness value for each record in the dataset;
generating a sorted list of records ordered from highest wobbliness value to lowest wobbliness value; and
providing the number of records from the sorted list having the highest wobbliness values as selected instances.

16. The method of claim 11, further comprising:
clustering the dataset;
selecting representative records from centermost records in each cluster; and
selecting the at least one key instance from the representative records.

17. The method of claim 16, wherein clustering the dataset comprises applying HDBSCAN.

18. The method of claim 11, further comprising visualizing the explanation using a display.

19. The method of claim 18, wherein the display is a virtual reality headset.

20. The method of claim 19, wherein the virtual reality headset renders a multi-user virtual office space.
